(19) United States
(12) Patent Application Publication
(10) Pub. No.: US 2014/0366002 A1
(43) Pub. Date: Dec. 11, 2014

(54) SEARCHING FOR AN ENTITY MOST SUITED TO PROVIDE KNOWLEDGE REGARDING AN OBJECT

(71) Applicants: Frank Jentsch, Muehlhausen (DE); Bare Said, Sankt Leon-Rot (DE); Frank Brunswig, Heidelberg (DE)

(72) Inventors: Frank Jentsch, Muehlhausen (DE); Bare Said, Sankt Leon-Rot (DE); Frank Brunswig, Heidelberg (DE)

(73) Assignee: SAP AG, Walldorf (DE)

(21) Appl. No.: 13/915,460

(22) Filed: Jun. 11, 2013

(51) Int. Cl. G06F 9/44

(52) U.S. Cl. CPC G06F 8/71
USPC 717/122

(57) ABSTRACT

In some example implementations, there is provided a method. The method may include receiving a message from a user interface, the message representing a request for an identity of an entity having information regarding a component of a system being developed; determining whether a cache includes the identity of the entity having the information regarding the component; accessing, from at least a repository, metadata including at least one of a version information for the component and an organization structure information, when the cache does not include the identity of the entity having the information regarding the component, and determining, based on the accessed metadata, the entity, when the cache does not include the identity of the entity having the information regarding the component. Related systems, methods, and articles of manufacture are also provided.

### TECHNICAL FIELD

This disclosure relates generally to data processing and, in particular, code development.

### BACKGROUND

Code development is extremely complex. It is thus not surprising that some software-based systems including thousands of components and millions of lines of code. Moreover, code development may take years. For example, it may take years to develop a core product, and that development may be iterative in the sense that updates, revisions, and other improvements to the core product may span years if not decades. As a consequence, it may be difficult to identify knowledge sources for a given product.

### SUMMARY

In some example implementations, there is provided a method. The method may include receiving a message from a user interface, the message representing a request for an identity of an entity having information regarding a component of a system being developed; determining whether a cache includes the identity of the entity having the information regarding the component; accessing, from at least a repository, metadata including at least one of a version information for the component and an organization structure information, when the cache does not include the identity of the entity having the information regarding the component; determining, based on the accessed metadata, the entity, when the cache does not include the identity of the entity having the information regarding the component; providing a first response to the received message, the first response including the determined entity having information regarding the component of the system being developed, when the cache does not include the identity of the entity having the information regarding the component; and when the cache does include the identity of the entity having the information regarding the component, providing a second response to the received message, the second response including the cached information identifying the entity having information regarding the component of the system being developed.

In some variations, one or more of the features disclosed herein including following features can optionally be included in any feasible combination. The cache may include information predetermined to enable determining the identity. The determining the entity may further include determining a score based on the version information. The determining the entity may further include determining the score based on version information including at least one of a total number of changes to the component, a frequency of changes made to the components, a length of responsibility for the component. The first response may include a score for the determined entity and an organization for the determined entity, wherein the score is determined based on version information.

Articles are also described that comprise a tangibly embodied machine-readable medium embodying instructions that, when performed, cause one or more machines (for example, computers, etc.) to result in operations described herein. Similarly, computer systems are also described that can include a processor and a memory coupled to the processor. The memory can include one or more programs that cause the processor to perform one or more of the operations described herein.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIGS. 1A-1B illustrate examples of user interfaces used in connection with determining an entity most likely to have knowledge regarding a component of a system under development according to some implementations of the current subject matter;

FIG. 2 illustrates an example a system for determining an entity most likely to have knowledge regarding a component of a system under development, according to some implementations of the current subject matter;

FIG. 3 depicts an example of a repository including metadata used in connection with determining an entity most likely to have knowledge regarding a component of a system under development, according to some implementations of the current subject matter; and

FIG. 4 depicts an example of a process for determining an entity most likely to have knowledge regarding a component of a system under development according to some implementations of the current subject matter.

### DETAILED DESCRIPTION

In a system development including software-based system development, identifying an entity, such as a person, persons, or a team, with knowledge including information regarding the system may be a challenge. This information may include metadata, such as one or more of the following: an original developer or an author of the system or component(s) of the system, a last entity to make a change to the system/component, an entity currently designated as a responsible entity for the component, and the like. However, selecting an entity to provide knowledge (for example, information) on a given component of a system based this metadata may not necessarily result in identifying the best knowledgeable entity for that component. For example, a system including a plurality of components may be developed by a first entity, but the components may undergo substantial enhancements since the original development, so selecting the original author/developer may not yield the most knowledgeable entity with respect to the system/component. Likewise, an entity may be recently designated as a responsible for a component, but have little experience or knowledge, so selecting the last entity to make a change may not yield a most knowledgeable entity with respect to the system/component. As such, a simple search for a person responsible for the system/component, a developer of the component, or an author of the component may not yield an entity with the so-called “best knowledge” on that component.

The subject matter disclosed herein relates to performing calculations based on version information for a system or a component. Moreover, historical organizational structural information may also be used to determine the entity most likely to have the best knowledge regarding a system or a component.

As used herein, the best knowledge may refer to having relevant or sufficient information for a given system or a component. Relevant or sufficient knowledge may correspond to current, accurate, and/or detailed information regarding the system or the component. As used herein, components may refer to objects, such as class implementations, database table definitions, development objects related to a component, and/or any other component, item, object, and the like of a software-based system.

To determine an entity most likely to have knowledge for a component of a system, such as a system under development, a repository may be accessed. This repository may include metadata, such as an author of a component, a date of creation of the component, the last entity to change the component, and/or a date change for the component. This metadata may be monitored, tracked, and/or provided by a tool, such as development tool (for example, a debugger, a development environment, and/or the like, where a system including the component is being developed).

Table 1 below depicts an example of metadata that may be provided to a repository for each of the components of a system being developed. Although the metadata of Table 1 may be considered useful in determining the most knowledgeable entity for a given component, this metadata may not be sufficient. For example, the entity that last changed a component may, as noted above, not necessarily have primary responsibility and knowledge regarding the component.

The information in Table 1 may, as noted, be provided to a repository by a tool, such as a development tool, although the repository may include a processor to gather the metadata as well.

Moreover, the metadata may be supplemented with additional metadata including version history information for the one or more components of the system. Further, the metadata may be supplemented with organizational structure information including historical structure. For example, a version tracker may track versions of the system including the components. Specifically, as each change is made to a component of a system, metadata regarding the change may be monitored, tracked, and/or gathered by the version tracker. An example of this metadata may include one or more of the following: who made the change; a date or dates for the change; the organizational structure of the entity making the change; and/or a degree of change (for example, a duration of the change, such as a time from a start of the change task until completion, or an amount of change, such as lines of code changed or file size differences, and the like).

In addition, the version tracker may, in some implementations, prompt an entity to describe the degree of change by presenting, at a user interface, a page where a user can indicate the degree of change (for example, a prompt asking a user to describe the change as a trivial change, a moderate change, and/or a complex change, although the degree of change may be surveyed in other ways as well). The response may be included in metadata as well.

In some example implementations, the version tracker may also access organizational history depicting a structure of an organization and the people in those organizations. For example, when a change is made by a given user, a version tracker may link the change to the identity of the person making the change and an organizational chart for that person. If another change is made at a later date by the same or another person, version tracker may link the other change to the identity of the same or other person making the change and a link to a version of an organizational structure for that person. These links may be stored in metadata at the repository to allow determining the identity of an entity (for example, a person, persons, organization) most likely to have the knowledge, such as the best knowledge, on a component of the system being developed.

As noted, the repository may include metadata which may be used to determine the identity of an entity most likely to have the best knowledge on a component of the system being developed. In some example implementations, a calculation engine may, based on the metadata, determine the identity of an entity most likely to have the best knowledge on a component of the system being developed. For example, the calculation engine may access the metadata including version history and organization structure. Given the accessed metadata, the calculation engine may identify one or more entities that have made changes to a given component. Next, the calculation engine may access the version history to determine the timeframe of the change(s) (for example, how recent the changes are) and/or the degree of change. The calculation engine may then determine a score based the timeframe of the changes and/or the degree of change. More recent changes to a component and/or more substantial changes may be weighted more heavily and thus result in a higher score than a less recent changes to the component and/or a minor substantial change. The calculation engine may then present a list of the entities ranked based on score, and this list may include (or be linked to) organizational information.

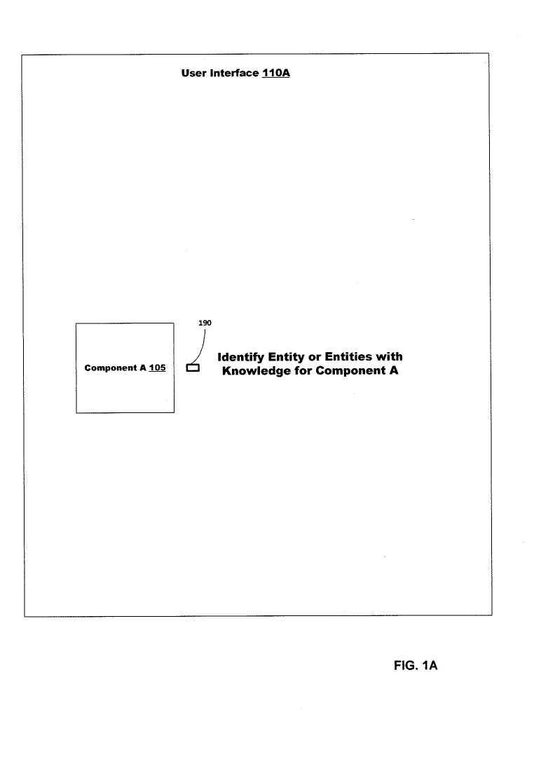

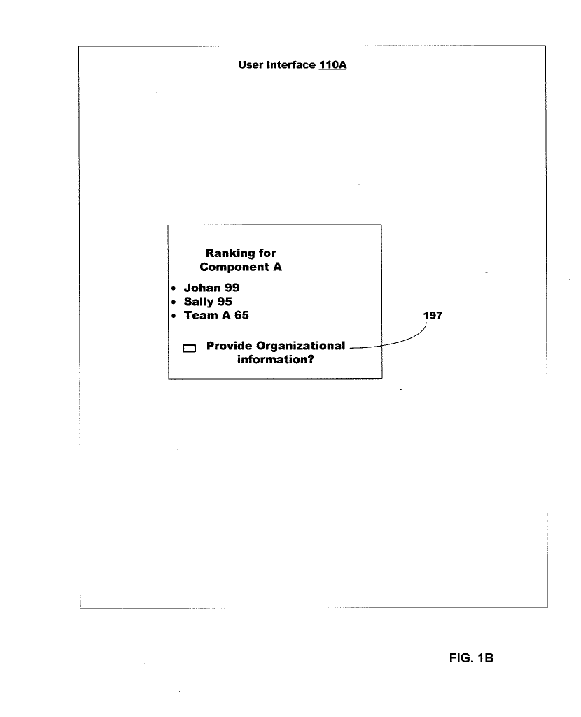

FIG. 1A depicts an example user interface 110A. User interface 110A may be associated with for example a development tool configured to enable a user to access information regarding a component under test.

In the example of FIG. 1A, a user may select a component A 105 and request the identity at 110A of an entity likely to have knowledge regarding component A 105. In this example, selection of 190 causes a message to be sent to a processor configured to determine an identity of an entity most likely to have knowledge regarding a component of the system being developed. The processor may then return a page with one or more entities, as depicted at FIG. 1B, most likely to have knowledge (for example, information, the best knowledge, and the like) regarding component A 105.

To illustrate further, the calculation engine may calculate a score and then rank, based the calculated score, a first developer, Johan, who made recent, substantial changes as the person/entity most likely to have the knowledge on a component. The calculation engine may also calculate a score and then rank, based the calculated score, Sally, who made less recent and/or less substantial changes as the second person/entity most likely to have the best knowledge on a component, and so forth. Based on this ranking, a page may be generated including one or more of Johan and Sally, and this page may be presented at a user interface to allow a current developer to select Johan. This page may also Johan's current contact information and/or organizational structure (for example, by selecting 197 at FIG. 1B). This contact and organizational structure may be stored in the repository along with other metadata.

Although FIG. 1B depicts examples of scores, such as 99, 95, and 88, other types and quantities of scores may be used as well. For example, the scores may be alphabetical, such as A, B, C, numerical, or a combination thereof. Moreover, the scores may be scaled to within a range, such as 1-100, 200-800, and/or any other range.

In some example implementations, the calculation engine may calculate scores and rank of the most knowledgeable entity or entities, such as person(s) and/or team(s). This scoring and ranking calculation may be based on one or more of the following factors: a total number and/or a frequency of changes of an object/component (for example, changes within recent past may be ranked higher); a length of responsibility for that object/component (for example, responsibility within recent past is ranked higher); a total number and/or a frequency of changes of other objects/components in the same or similar package; a length of responsibility for other objects in the same or similar package; other members of the same team not directly involved into changes and responsibilities of that object so far; and/or the like. In some example implementations, these and other factors may be used to form a score in accordance with the following:

Score=(factor_{—}1×weight_{—}1)+(factor_{—}2×weigh_{—}2), Equation 1,

wherein the factor_{—}1 represents a first factor and factor_{—}2 represents a second factor, and wherein the weights_{—}1 and weight_{—}2 are used to vary the relative importance of a factor in the score calculation.

Although the previous example illustrates two factors, other quantities of factors may be used as well. The calculation may thus rank the entities based on the calculated score. In some example implementations, the calculation engine may provide a plurality of entities sorted based on score to a user interface so that a user can select an entity having the best knowledge, although the calculation engine may provide a single entity, such as the highest scoring entity, to the user interface as well.

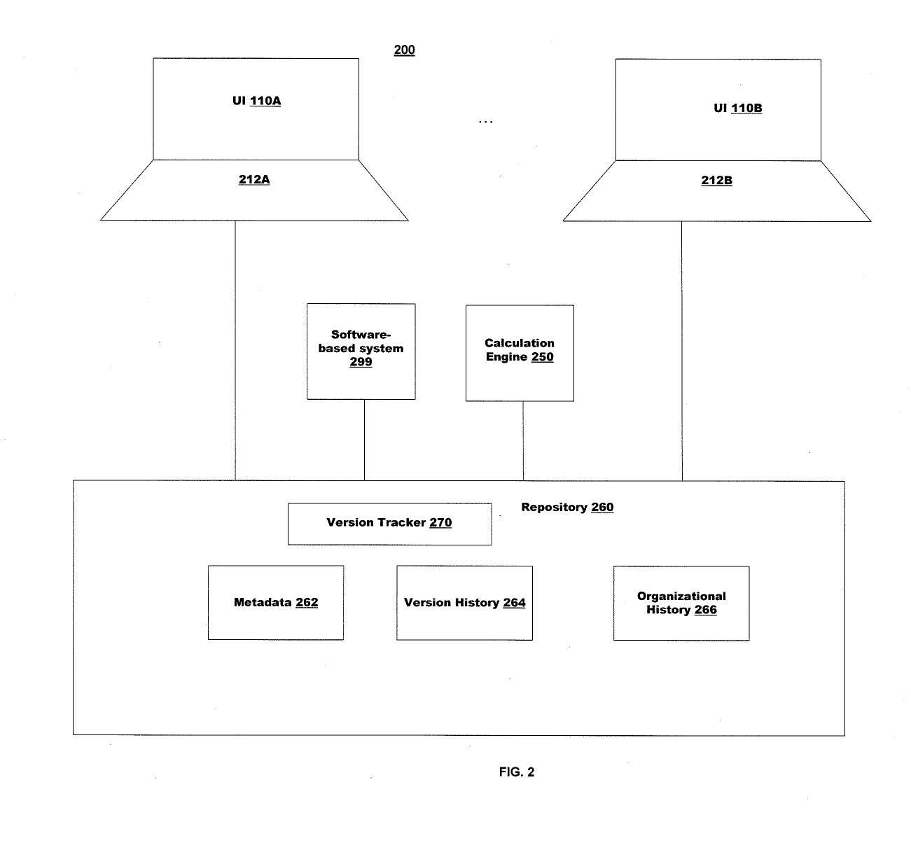

FIG. 2 depicts an example system 200 including one or more processors 212A-212B, such as computers, tablets, and other processor-based devices. The processors 212A-B may be used for example during the development of a software-based system 299 including one or more components and/or objects. The processors 212A-B may include user interfaces 110A-B, such as a browser, client application, and/or the like, and these user interfaces 110A-B may be associated with a development tool, such as a debugger, code test framework, and the like.

The system 200 may further include a calculation engine 250 configured to perform the ranking, determination, and/or selection of one or more entities most likely to have information for a given component/object.

The system 200 may also include a repository 260 including metadata 262. The metadata may include one or more of the following: version information for one or more components of a system being developed; organizational structures over time to allow identifying an entity including a person or an organization that may have been responsible for one or more components of the system; an author of a component or its change; a date of creation or change for the component; a last entity to change the component; an entity currently designated as a responsible entity for the component; a degree of change; an amount of change; and/or the like.

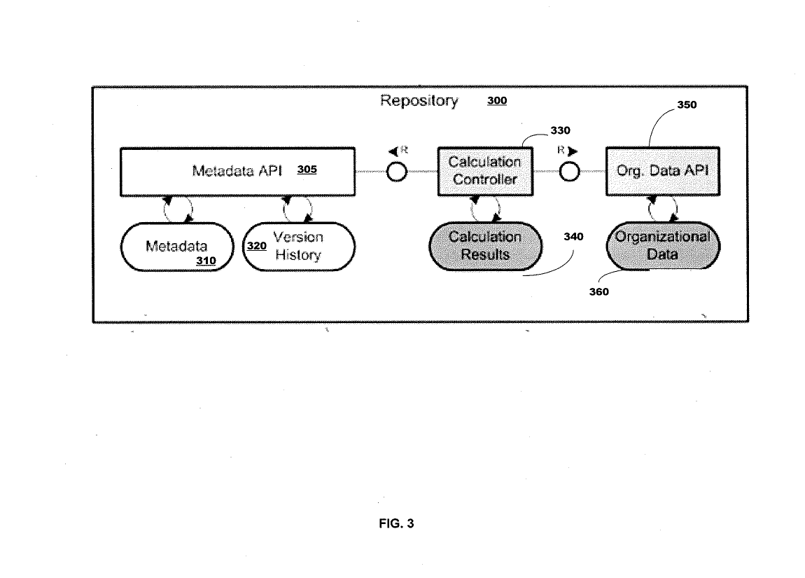

FIG. 3 depicts another example of a repository 300. The repository 300 may include an application program interface (API) 305, from which metadata 310 including version history 320 and other metadata can be accessed by calculation engine 260, version tracker 270, and/or system 299. The repository 300 may further include a calculation controller 330 for pre-calculating the rankings and an entity most likely to have knowledge for a given component and store those results at 340. This pre-calculation may enable a quicker search for the entity when requested by user interface 110A and/or an application. The repository 300 may also include organizational history 360, which can be accessed via API 350 by calculation engine 260, version tracker 270, and/or then like.

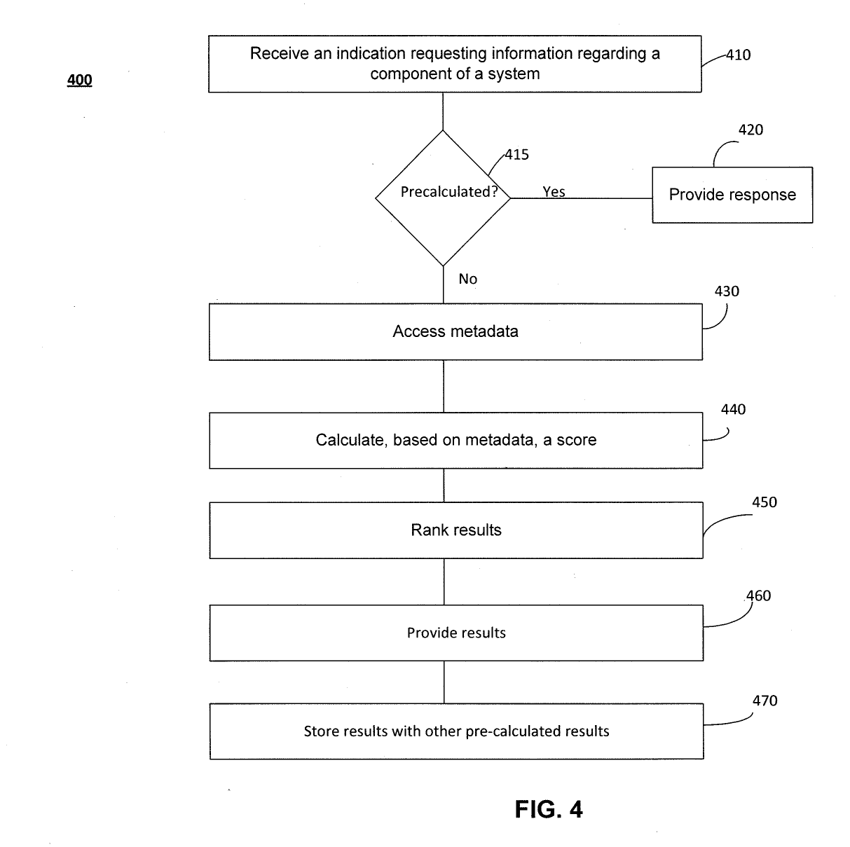

FIG. 4 depicts a process 400 for determining an entity having information with respect to a component of a system. The description of process 400 also refers to FIGS. 1A, 1B, and 2.

At 410, an indication may be received for a request for information regarding a component of a system including a plurality of components. For example, as a component is being accessed during development including test, debugging, and the like, a user may request more information for a certain component. Component A 105 may be selected at 190, which generates a request message to be sent by the user interface 110A to repository 260. This request message may identify the component and the user interface sending the request.

At 415, a determination may be made whether information for the component has been pre-calculated. For example, repository 260 may determine whether the most knowledgeable entity for a given component, such as component A 105, has been pre-calculated by the calculation engine 250.

If pre-calculated (yes at 415 and 420), a response may be provided at 420. This response may identify one or more of the entities knowledgeable regarding a given component, such as component A 105. For example, the response sent to user interface 110A at 420 may indicate “Johan,” with a rank pre-calculated by the calculation engine 250 of 99, although other entities, scores, and the like may be provided as well. Moreover, this response may indicate the organizational structure information for “Johan” obtained from organizational history 266.

If the requested information has not been pre-calculated (no at 415 and 430), metadata may be accessed. For example, the calculation engine 250 may access metadata 262 including version histories 264 and organizational history 266 to obtain metadata for use in the calculation of a score at 440.

At 440, a calculation may be performed to determine a score. The score may be used as an indicator to determine the identity of an entity most likely to have knowledge or information on the component. For example, a score may be determined based on a combination of one or more of the following factors: a total number and/or a frequency of changes to an object/component; a length of responsibility for that object/component; a total number and/or a frequency of changes to other objects/components in the same or similar package; a length of responsibility for other objects in the same or similar package; and/or the like. Moreover, the combination may be a weighted sum of these factors. For example, more recent or more substantial changes to a component may be weighted more heavily than less recent or less substantial changes to the component. In some example implementations, the score may be determined as described above with respect to Equation 1.

The calculation engine 250 may then rank the results at 450. For example, if three entities are identified and scored, the calculation engine 250 may perform a ranking of the scores, so that the entity with the highest score (which may represent the greatest likelihood of having information on the component) may be provided first on a list sent at 460 to user interface 110A, although only the highest ranked entity may be provided at 460 to user interface 110A as well.

At 470, the ranked results may be stored in a cache accessible by repository 260 with other pre-calculated rankings for the component. These cached results may be used at for example 415 and 420 to service requests received at 410.

The described system includes version history to determine best knowledgeable persons of a development object. Furthermore, organizational data is linked to the software structure and allows calculation of the best knowledgeable unit or team. Combination of both aspects has following ad-vantages: —Effectiveness of the support process can be increased. Best knowledgeable persons for a certain piece of software can be found automatically. —Derivation of content for a skill database is possible and would have an up-to-date data quality compared to manually maintained skill databases. —Potential candidates for setup of new teams can be proposed based on system-tracked participation of development activities. —Best knowledgeable persons can be selected for specific migration or refactoring activities.

The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

The systems and methods disclosed herein can be implemented as a computer program product, i.e., a computer program tangibly embodied in an information carrier, e.g., in a machine readable storage device or in a propagated signal, for execution by, or to control the operation of, data processing apparatus, for example, a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

As used herein, the term “user” can refer to any entity including a person or a computer.

Although ordinal numbers such as first, second, and the like can, in some situations, relate to an order; as used in this document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the invention, which is defined by the scope of the appended claims. Other implementations are within the scope of the following claims.

These computer programs, which can also be referred to programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example, as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including, but not limited to, acoustic, speech, or tactile input.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include clients and servers. A client and server are generally, but not exclusively, remote from each other and typically interact through a communication network. The relationship of client and server arises by virtue of computer programs running on the respective computers and having a client-server relationship to each other.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

What is claimed:

1. A method, comprising:
receiving a message from a user interface, the message representing a request for an identity of an entity having information regarding a component of a system being developed;
determining whether a cache includes the identity of the entity having the information regarding the component;
accessing, from at least a repository, metadata including at least one of a version information for the component and an organization structure information, when the cache does not include the identity of the entity having the information regarding the component;
determining, based on the accessed metadata, the entity, when the cache does not include the identity of the entity having the information regarding the component;
providing a first response to the received message, the first response including the determined entity having information regarding the component of the system being developed, when the cache does not include the identity of the entity having the information regarding the component; and
when the cache does include the identity of the entity having the information regarding the component, providing a second response to the received message, the second response including the cached information identifying the entity having information regarding the component of the system being developed.

2. The method of claim 1, wherein the cache includes information predetermined to enable determining the identity.

3. The method of claim 1, wherein the determining the entity further comprises:
determining a score based on the version information

4. The method of claim 1, wherein the determining the entity further comprises:
determining the score based on version information including at least one of a total number of changes to the component, a frequency of changes made to the components, a length of responsibility for the component.

5. The method of claim 1, wherein the first response includes a score for the determined entity and an organization for the determined entity, wherein the score is determined based on version information.

6. A system comprising:
at least one processor; and
at least one memory including computer code, which when executed by the at least one processor provides operations comprising:
receiving a message from a user interface, the message representing a request for an identity of an entity having information regarding a component of a system being developed;
determining whether a cache includes the identity of the entity having the information regarding the component;
accessing, from at least a repository, metadata including at least one of a version information for the component and an organization structure information, when the cache does not include the identity of the entity having the information regarding the component;
determining, based on the accessed metadata, the entity, when the cache does not include the identity of the entity having the information regarding the component;
providing a first response to the received message, the first response including the determined entity having information regarding the component of the system being developed, when the cache does not include the identity of the entity having the information regarding the component; and
when the cache does include the identity of the entity having the information regarding the component, providing a second response to the received message, the second response including the cached information identifying the entity having information regarding the component of the system being developed.

7. The system of claim 6, wherein the cache includes information predetermined to enable determining the identity.

8. The system of claim 6, wherein the determining the entity further comprises:
determining a score based on the version information

9. The system of claim 6, wherein the determining the entity further comprises:
determining the score based on version information including at least one of a total number of changes to the component, a frequency of changes made to the components, a length of responsibility for the component.

10. The system of claim 6, wherein the first response includes a score for the determined entity and an organization for the determined entity, wherein the score is determined based on version information.

11. A non-transitory computer-readable medium including computer code which when executed by at least one processor provides operations comprising:
receiving a message from a user interface, the message representing a request for an identity of an entity having information regarding a component of a system being developed;
determining whether a cache includes the identity of the entity having the information regarding the component;
accessing, from at least a repository, metadata including at least one of a version information for the component and an organization structure information, when the cache does not include the identity of the entity having the information regarding the component;
determining, based on the accessed metadata, the entity, when the cache does not include the identity of the entity having the information regarding the component;
providing a first response to the received message, the first response including the determined entity having information regarding the component of the system being developed, when the cache does not include the identity of the entity having the information regarding the component; and
when the cache does include the identity of the entity having the information regarding the component, providing a second response to the received message, the second response including the cached information identifying the entity having information regarding the component of the system being developed.

12. The non-transitory computer-readable medium of claim 11, wherein the cache includes information predetermined to enable determining the identity.

13. The non-transitory computer-readable medium of claim 11, wherein the determining the entity further comprises:
determining a score based on the version information

14. The non-transitory computer-readable medium of claim 11, wherein the determining the entity further comprises:
determining the score based on version information including at least one of a total number of changes to the component, a frequency of changes made to the components, a length of responsibility for the component.

15. The non-transitory computer-readable medium of claim 11, wherein the first response includes a score for the determined entity and an organization for the determined entity, wherein the score is determined based on version information.
